(19) United States
(12) Patent Application Publication
(10) Pub. No.: US 2017/0337526 A1
(43) Pub. Date: Nov. 23, 2017

(54) SYSTEM FOR MANAGING VIRTUAL TRANSMISSION OF MONEY FROM A SENDER TO A RECIPIENT

(71) Applicant: PMTP sagl, Tremona-Mendrisio (CH)

(72) Inventors: Alfredo VILLA, Lugano Pregassona (CH); Maurizio CODONI, Tremona (CH)

(21) Appl. No.: 15/158,612

(22) Filed: May 19, 2016

(51) Int. Cl. G06Q 20/06; G06Q 20/16

(52) U.S. Cl. CPC G06Q 20/06; G06Q 20/16

(57) ABSTRACT

A method for managing transmission of money via email from a sender to a recipient, comprising the steps of:
(a) providing a server system comprising one or more servers, the server system comprising a processing unit;
(b) providing a user list to the server system, comprising identification of one or more users;
(c) providing a money account to each user of said user list, each money account allowing debiting or crediting or money, wherein the processing unit
   (s1) receives an email sent by a sender towards a recipient, providing information to an amount of money to be transferred from the sender to the recipient;
   (s2) determines if the name of the sender of step (s1) is named in said user list; (s3) determines if the name of the recipient is named in said user list; and wherein the processing unit, as a function of the result of said steps (s2) and (s3):
   (s4a) transfers the amount of money of step (s1) from the money account of the sender to the money account of the recipient when both the sender and the recipient are named in said user list;
   (s4b) sends a virtual certificate to the recipient, allowing the recipient to interact with the processing unit to collect the amount of money of step (s1), when only the sender is named in said user list;
   (s4c) provides instruction to the sender, allowing him to interact with the processing unit to credit the amount of money of step (s1) to the money account of the recipient, when only the recipient is named in said user list.

The present invention relates to a system and a method for managing virtual transmission of money (i.e. a virtual transaction) from a sender to a recipient. In particular, the present invention relates to a system and a method for improving easiness and safety of the operation. With virtual transaction it is meant the sending of money from a sender to a receiver via electronic means, i.e. without the exchange of real money such as banknotes and coins. These virtual transaction are generally carried out via the Internet, by means of a credit card.

It is known that many users do not exchange money by means of virtual transaction, because they do not want to exchange their information (e.g. number of credit card) with third parties. Also, many users are not provided with a credit card or similar means to carry out a virtual transaction.

There is thus the need of a method and a system for managing virtual transmission of money from a sender to a recipient, in a safe and easy manner.

It is thus an object of the present invention to provide such a method and such a system.

It is a further object of the present invention to provide a method and a system for managing virtual transmission of money from a sender to a recipient which is more versatile than the known ones.

These and other objects are achieved by a method and a system according to the independent claims.

Preferred embodiments are recited in the dependent claims.

According to an embodiment, a method for managing transmission of emails from a sender to a recipient comprises the steps of:

(a) providing a server system comprising one or more servers, the server system comprising a processing unit;
(b) providing a user list to the server system, comprising identification of one or more users;
(c) providing a money account to each user of the user list, each money account allowing debiting or crediting or money, wherein the processing unit
(s1) receives an email sent by a sender towards a recipient, providing information to an amount of money to be transferred from the sender to the recipient;
(s2) determines if the name of the sender of step (s1) is named in the user list;
(s3) determines if the name of the recipient is named in the user list;
and wherein the processing unit, as a function of the result of the steps (s2) and (s3):
(s4a) transfers the amount of money of step (s1) from the money account of the sender to the money account of the recipient when both the sender and the recipient are named in the user list;
(s4b) sends a virtual certificate to the recipient, allowing the recipient to interact with the processing unit to collect the amount of money of step (s1), when only the sender is named in the user list;
(s4c) sends instruction to the sender, allowing him to interact with the processing unit to credit the amount of money of step (s1) to the money account of the recipient, when only the recipient is named in the user list;

It should be noted that the “user list” may be of any known kind that can be read and managed by the server system (in particular by the processing unit of the server system), and it is typically a digital database.

The processing unit is programmed in a known way to recognize the incoming/outgoing email that contain instruction relating a virtual transaction. This may be e.g. done by analyzing the attachments of the email. As a result, the processing unit will process with the above mentioned method only the emails actually containing information relating a virtual transaction.

Thanks to the present embodiment, the transaction is managed by the server system, and there is no exchange of personal information (e.g. credit card number) between sender and receiver.

The money account can be any kind of system for virtually managing money. As an example the money account may be associated to a credit card number, or to a bank account. Also, as better discussed later, the users may acquire a number of virtual coins (credits) to be exchanged between the users themselves.

Thanks to the present method, it is possible to manage transaction between sender and receiver even if only one between sender and receiver is named in the user list.

The present method may also manage transaction between a sender and multiple receiver. Steps (s1)-(s3) and one of steps (s4a), (s4b), (s4c) are repeated for each recipient.

According to an embodiment each transfer of money is inserted within a transaction database. This allow to track each operation, and to solve disputes in case of errors in the transactions. In particular, it is preferred that the transaction database contains information relating the sender and the recipient of each transfer of money. Preferably other data is also contained (e.g. amount of money, time of the transfer, etc.)

According to a preferred embodiment, the server system hosts a web portal. Preferably, the user of the above mentioned step (b) (i.e. the users mentioned in the user list) are registered users of the web portal.

The operation of “registering” to a web portal is known in the field of web portals.

Thanks to the web portal, the users can easily interact with the server system.

As a result they can e.g. provide to the server system information about the money account, they can easily instruct the server system to carry out a virtual transaction, etc.

According to an embodiment, if the processing unit determines that the sender or the receiver is not registered to the web portal, further than step (s4b) or (s4c), the sender is invited to register to the web portal.

As mentioned, transaction between registered users are processed faster that an transaction between a registered and a non-registered sender.

According to an embodiment, the users have an email account on a server of the server system.

Thanks to this, the server system may easily manage the emails of the user.

According to an embodiment, the account of money comprises a number of virtual credits (i.e. virtual coins) of the web portal. Transaction between user may thus be particularly fast, secure and traceable.

According to an embodiment, the account of money comprises association to a credit card. This is an easy way to link the account of money to the real money of the users.

An embodiment of the present invention further provides for a system for managing transmission of money via email from a sender to a recipient, the system comprising a server system comprising one or more servers, and a processing unit, the server system being configured to: obtain a user list comprising identification of one or more users; providing an account of money to each user of the user list; wherein the server system is configured to run computer executable instructions to: receive an email sent by a sender towards a recipient, providing information to an amount of money to be transferred from the sender to the recipient; determine if the name of the sender of step is named in the user list; determine if the name of the recipient is named in the user list; transfer the amount of money of step from the money account of the sender to the money account of the recipient when both the sender and the recipient are named in the user list; send a virtual certificate to the recipient, allowing the recipient to interact with the processing unit to collect the amount of money of step, when only the sender is named in the user list; send instruction to the sender, allowing him to interact with the processing unit to credit the amount of money of step to the money account of the recipient, when only the recipient is named in the user list;

Other feature, advantages and details appear, by way of example only, in the following detailed description of embodiments, with reference to the accompanying drawings, wherein:

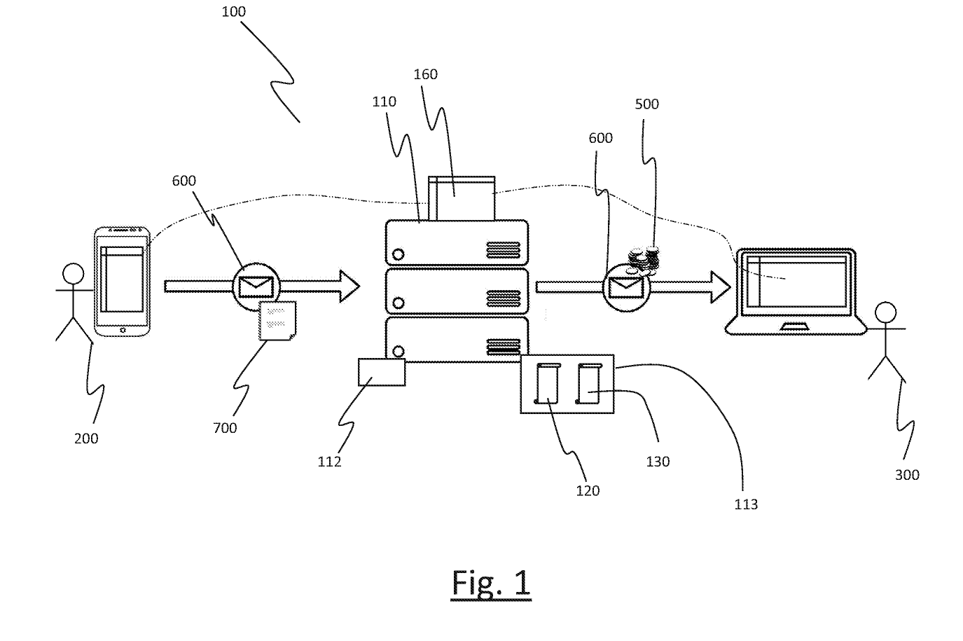

FIG. 1 is a schematic view of a system according to an embodiment of the invention;

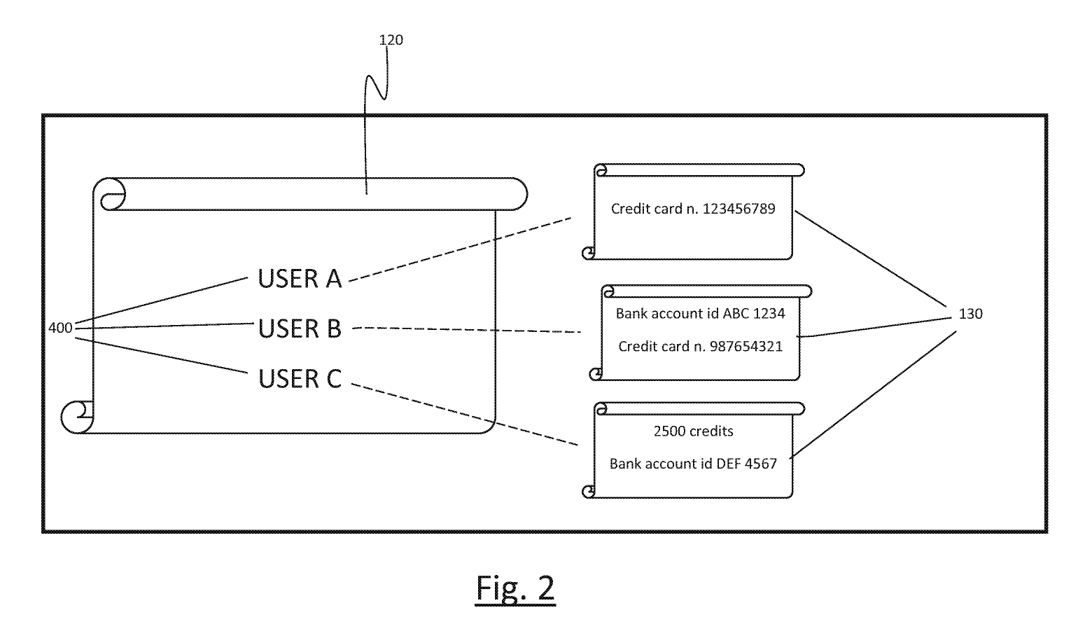

FIG. 2 is a schematic view of a user list according to an embodiment of the invention;

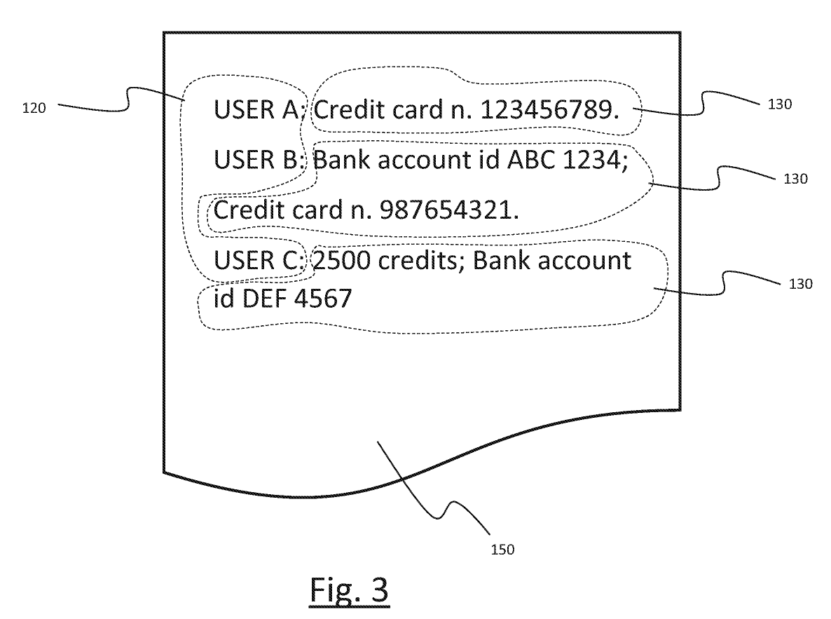

FIG. 3 is a schematic view of the content of FIG. 2, organized in a database;

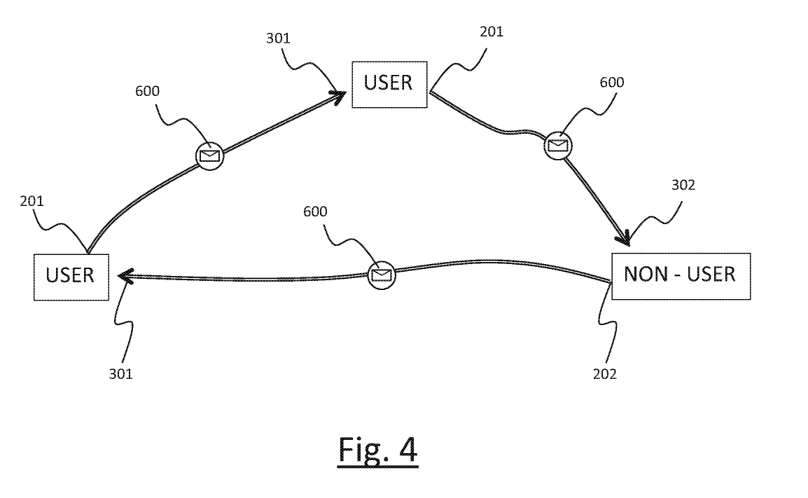

FIG. 4 is a schematic view of the management of the emails between users named in the user list and user not named in the user list of an embodiment of the invention;

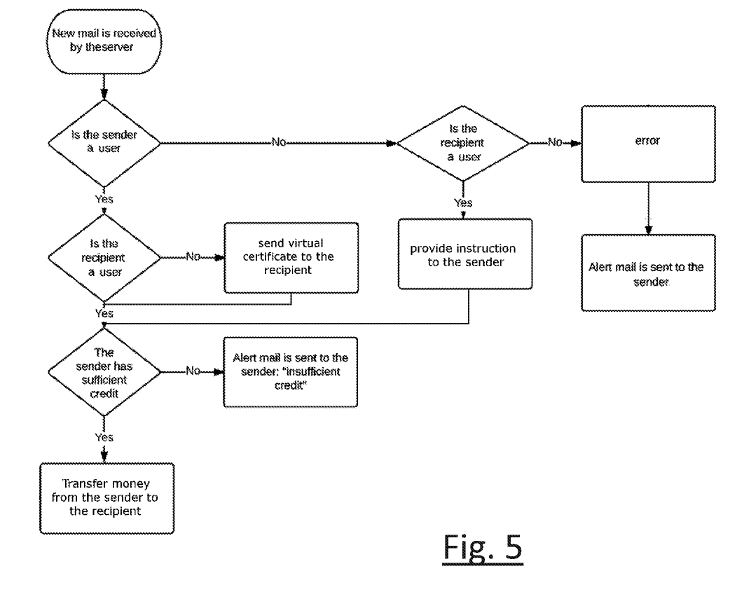

FIG. 5 is a flow-chart, showing the operation of an exemplary embodiment of the invention.

According to an embodiment, a system 100 for managing virtual transmission of money 500, from a sender 200 to a recipient 300. The system 100 comprises a server system 110 comprising one or more servers 111 and a processing unit 112.

In the figures, only one server 111 is shown. In other embodiments, a plurality of servers 111 may be connected in a known way, typically by means of a network over the Internet, to form a server system 110.

The server system 100 is configured to obtain a user list 120 comprising identification of one or more users 400.

The server system 100 (and in particular the processing unit 112) is configured in a known way (i.e. it is programmed in a known way) to manage both the incoming and outgoing emails 600 of the users 400. In particular, the processing unit 112 is configured to recognize the emails 600 that contain information 601 relating a virtual transmission of money 500 to or from a user 400. Typically, the information relating a virtual transaction are contained in an attachment of the email 600.

The processing unit 112 also provides a money account 130 to each user 400 of the user list 120. The money account may contain information relating one or more credit cards, bank account, etc., so that money 500 can be credited to such credit cards, bank account, etc. Also, as better discussed later, the money account may contain information relating a number of virtual coins that may be debited or credited to a user 400. In general, during a virtual transaction of a user 400, money 500 is credited or debited to the user 400 via the money account 130.

As mentioned, the processing unit monitors the incoming and outgoing emails 600 of the users 400. As a result, as better discussed later, there are three possible situation (shown in FIG. 4):

(i) both the sender 200 and the recipient 300 are users;
(ii) only the sender 200 is a user;
(iii) only the recipient 300 is a user;

For clarity, difference will be made between senders and recipients, according to they are user or not (i.e. whether they are named or not in the user list 130). A sender that is a user will be referenced as user sender 201; a sender that is not a user will be referenced as a non-user sender 202. Similarly a recipient that is a user will be referenced as user recipient 301; a recipient that is not a user will be referenced as a non-user recipient 302. When no difference is made between user and non-user, the generic definition “sender” and “recipient” will be used.

The user list 120 and the money account 130 were disclosed as being separate and distinct elements. As shown in the figures, they may be part of a single database 150. As an example a single list may contain the name of the users together with the number of their credit card or the number of virtual coins they possess.

According to an embodiment, the server system 100 is provided with a memory 113 to store, among others, the user list 120 and/or the money account 130.

In different embodiment, the above mentioned data may be stored remotely, i.e. not on the server system 100. In such an embodiment, the server system 100 should be able to retrieve the data when needed, e.g. by means of a proper connection (e.g. cabled or wireless) to the place wherein the data is stored.

According to an embodiment, the server system 100 hosts a web portal 160. The web portal 160 provides, among others, an interface for the senders 200 and the recipient 300.

The senders 200 and the recipient 300 can connect to the web portal 160 by way of a proper network, which is typically the Internet. The users 400 may thus connect to the web portal by means of a device provided with Internet access, such as personal computer, mobile phones, tablets, etc.

Preferably, the web portal allows the users 400 to “register” to the web portal. As known in the art, a “registered user” of a web portal, is a user that, providing identification data (e.g. a username and a password) can access particular functions of the web portal 160. Moreover, a registered user can store on the web portal 160 personal information (e.g. name, email address, information for the money account, etc.), that allows him to quickly operate in the web portal 160, (e.g. sending money 500 via email to a recipient 300).

As mentioned, the information relating the money account 130 may be any information providing debiting or crediting or money 500. As an example, a user may provide to the web portal data relating its credit card, or other known digital payment services (e.g.) Paypal®. The money account of such a user will thus essentially be the number of its credit card or the information relating its digital payment service.

Otherwise, the web portal 160 may sell virtual coins or “credits”, that are needed to carry out certain functions. As an example, credits may be used to buy other services provided by the web portal 160; otherwise the credits may be converted into real money 500, e.g. they can be credited to a bank account of the user. In this case, the transaction between user are carried out only via virtual coins, while the user may convert this virtual coins into real money 500 in a different moment. As a result there is no need to exchange personal information (number of credit card, information relating a bank account) between the sender 200 and the recipient 300 of a virtual transaction carried out via the web portal 160.

The money account 130 of a user 400 can also contain different information for crediting/debiting money 500. As an example, the money account 130 of a user 400 may either contain information relating a credit card and a number of credits. When he is a sender 201 of an email 600 containing information relating a virtual transaction, he may either choose whether to send money 500 in the form of credits or via the credit card. Similarly, the recipient 301 (provided that he is a user 400, too) may choose to receive money 500 in the form of virtual coins (i.e. credits 131), or e.g. debited to its bank account, whose information are stored in his/her money account 130.

According to an embodiment, the system 100 provides an email address to the users 400. Preferably the email address share the domain of the web portal 160, i.e. it is of the type “user@webportal.com”. This allows the processing unit 112 to easily manage the emails 600 of the user 400; in particular, this solution allows the processing unit 112 to quickly recognize the emails 600 that actually contain information relating a virtual transaction.

According to an embodiment, the users may be allowed to use their email address freely, e.g. to send/receive any kind of email to both registered users of the web portal 160 and to non-registered user of the web portal 160. In particular, the emails that do not contain information relating a virtual transaction are not processed according the present method, i.e. they can be ignored or else processed differently. If an email is sent to a non-registered user, the email may be completed automatically by the processing unit 112, in order to add an invitation to register to the web portal, to take advantage of the services provided by the system itself. Otherwise, if the mail is sent by a non-registered user (i.e. by a non-user sender 202), the recipient 301 may be asked if he/she wants to invite the non-registered user (i.e. the non-user sender 202) to register to the web portal 160.

Operation of the above disclosed system 100 will be now discussed in detail.

At first, a sender 200 sends an email 600 to a recipient 300 that contains information relating to an amount of money 500 to be transferred from the sender 200 to the recipient 300.

The server system 110 intercepts the email 600 and the processing unit 112 verifies the identity of the sender 200 and of the recipient 300. In particular, the processing unit verifies if the sender 200 and/or the recipient 300 are named in the user list 130. As mentioned, the sender 200 may either be a user sender 200 or a non-user sender 202, while the recipient 300 may be a user recipient 301 or a non-user recipient 302. At least one between sender 200 and recipient 300 is a user 400, so that there are three cases, that are discussed separately.

In a first case, both the sender 201 and the recipient 301 are users 400, typically they are registered user of the web portal 160. In this case, the processing unit 112 can operate on the money account of both the sender 201 and the recipient 301 to transfer money 500 from the sender 201 to the recipient 301.

This may be done directly, or requiring confirmation from one or more of the users 400 involved in the virtual transaction. As an example, the email received by the recipient may contain a link to the web portal, where he is asked to confirm his data and to accept the payment. Once this is done, a further email, automatically generated, may be sent to the sender 201, asking him to confirm the payment, so that money 500 can be transferred from the sender 201 to the recipient 300.

As mentioned, the virtual transaction may be carried out in different ways, according to the information stored on the money account 130 of each user 400. As an example, the sender 201 may have a money account where the number of its credit card is stored. The recipient 300 may have only a number of virtual coins, i.e. the above mentioned “credits”, on his money account. The processing unit will manage the virtual transaction, debiting an amount of money 500 on the credit card of the sender, converting such an amount in virtual coins, and finally crediting these virtual coins to the money account of the recipient.

According to a second case, the sender 201 is a user 400, while the recipient 302 is not a user. In this case, money 500 can't be transferred to the money account of the non-user recipient 302, as the non-user recipient 302 is not provided with a money account 130.

As a result, a virtual certificate 700 is sent to the non-user recipient, allowing him to collect his money 500 from the money account 130 of the user sender 201. Typically the virtual certificate 700 is used to interact with the processing unit 112, typically via the web portal 160, allowing the non-user recipient to verify his identity, to obtain the authorization to collect money 500 from the money account of the user sender 201, etc.

In particular, the virtual certificate 700 may contain identification of the user sender 201, and an authorization to debit a certain amount of money 500.

As before, when the non-user recipient 302 tries to collect his money 500, an email is sent to the user sender to authorize the virtual transaction. Both the user sender 201 and the non-user recipient 302 are preferably asked how they prefer to have their money 500 debited/credited. In particular, the user sender 201 may be asked how to debit money 500 from his money account (e.g. via a credit card, debiting him an amount of virtual coins, from his bank account, etc.). The non-user recipient, preferably via the web portal 160, is asked information allowing the processing unit 112 to credit him an amount of money 500 from the money account of the user sender 201. As an example, the non-user recipient may provide information of his bank account to the web portal 160, allowing the processing unit 112 to credit him an amount of money 500 to such a bank account.

In a third case, the sender 202 is a non-user and the recipient is a user 400. In this case, typically the email 600 contains an attachment that is recognized by the processing unit as an intention to pay the user recipient 302. Such an attachment may be collected e.g. by the non-user sender 202 form the web portal 160, or it may be sent to the non-user sender 202 directly by the user recipient 301.

Subsequently the processing unit 112 sends (directly or indirectly, e.g. via the user recipient 301) information relating how to credit money 500 to the user recipient 301. As an example he may be informed on how to credit money 500 to the money account 130 of the user recipient 301. Otherwise, the non-user sender 202 may collect (e.g. from the web portal 160) the required information to send money 500 to the non-user recipient.

A non-user sender 202 may, temporarily or permanently, add his name to the user list. As an example, a non-user sender may write an email through the web portal 160. In such a case, the non-user sender 202 may not be forced to register to the web portal 160. In general, a non-user sender 202 may be asked to provide information to the processing unit 112 allowing him to be temporarily added to the user list, and allowing a transaction of money 500 from the non-user sender 202 to a recipient 300. This information may be asked at the writing of the email, or it may be contained in the email 600 itself. As an example, an attachment of the email 600 may contain instruction to the server processing unit to (temporarily) add the name of the sender of the email to the user list 120. In such a case a temporarily money account 130 is created for the sender, too, allowing the transaction to be carried out.

Similarly, a non-user recipient may interact with the processing unit 112 (e.g. via the web portal 160) to temporarily add his name to the user list 120.

According to an aspect, a virtual certificate 700 is exchanged between the sender 200 and recipient 300, independently from the kind of sender 200 and recipient 300, containing information relating both the sender and the recipient. This virtual certificate 700 is typically exchanged with the email 600. The virtual certificate 700 may be read by the processing unit 112 to allow authorization of the virtual transaction.

In other words, after the processing unit verifies the identities of the sender 200 and of the recipient 300 (i.e. after it verifies whether they are named in the user list 120), the processing unit 112 verifies the information of the virtual certificate 700 exchanged between sender 200 and recipient 300, to authorize the virtual transaction. In particular, the processing unit 112 may verify if the instructions relating to the virtual transaction coincide with the information contained in the virtual certificate 700 exchanged between sender 200 and receiver 300.

Before executing the transaction, the processing unit 112 may verify that the sender 201 has enough funds to carry out the transaction. This may be done e.g. verifying the money account 130 of a user sender, or verifying the information provided by the non-user sender 202 to carry out the transaction. If the sender 200 has enough funds, the transaction is carried out. If the sender 200 is not provided with enough funds, the sender 200 is warned accordingly, e.g. an email is sent the sender 200. Preferably, the recipient is warned, too.

Preferably, after the transaction is carried out, the processing unit adds information of the transaction in a transaction database. Such an information typically contains at least the name of the sender, the name of the recipient and the amount of money transferred. Other data may be provided, e.g. the date of the operation, the kind of transaction and the kind of money used in the transaction (e.g. from a credit card to virtual coins), etc. In other word, each transaction managed by the processing unit is preferably tracked into the transaction database.

Finally, it may be the case that the server processing unit tries to process an email 600, but it verifies that neither the sender 200 nor the receiver 300 are named in the user list 120. As a result, there may be an error, and so at least the sender 200 (preferably both the sender 200 and the recipient 300) is warned. They may be also invited to register themselves, so as to carry out virtual transactions.

While exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

1) A method for managing transmission of money via email from a sender to a recipient, comprising the steps of:
(a) providing a server system comprising one or more servers, the server system comprising a processing unit;
(b) providing a user list to the server system, comprising identification of one or more users;
(c) providing a money account to each user of said user list, each money account allowing debiting or crediting or money, wherein the processing unit
(s1) receives an email sent by a sender towards a recipient, providing information to an amount of money to be transferred from the sender to the recipient;
(s2) determines if the name of the sender of step (s1) is named in said user list;
(s3) determines if the name of the recipient is named in said user list;
and wherein the processing unit, as a function of the result of said steps (s2) and (s3):
(s4a) transfers the amount of money of step (s1) from the money account of the sender to the money account of the recipient when both the sender and the recipient are named in said user list;
(s4b) sends a virtual certificate to the recipient, allowing the recipient to interact with the processing unit to collect the amount of money of step (s1), when only the sender is named in said user list;
(s4c) provides instruction to the sender, allowing him to interact with the processing unit to credit the amount of money of step (s1) to the money account of the recipient, when only the recipient is named in said user list.

2) The method of claim 1, wherein each transfer of money is inserted within a transaction database.

3) The method of claim 2, wherein the transaction database contains information relating the sender and the recipient of each transfer of money.

4) The method according to claim 1, wherein the server system hosts a web portal.

5) The method according to claim 4, wherein the user of said step (b) are registered users of said web portal.

6) The method according to claim 5, wherein the users have an email account on a server of said server system.

7) The method according to claim 4, wherein the account of money comprises a number of virtual credits of the web portal.

8) The method according to claim 1, wherein the account of money comprises association to a credit card.

9) The method according to claim 1, wherein the name of the sender or the name of the recipient of the email of step (s1) is added to the user list during step (s1).

10) The method according to claim 1, wherein the name of the sender of the email of step (s1) is added to the user list at writing of the email of step (s1).

11) A system for managing transmission of money via email from a sender to a recipient, the system comprising a server system comprising one or more servers, and a processing unit, the server system being configured to:
obtain a user list comprising identification of one or more users;
providing an account of money to each user of said user list;
wherein the server system is configured to run computer executable instructions to
receive an email sent by a sender towards a recipient, providing information to an amount of money to be transferred from the sender to the recipient;
determine if the name of the sender of step is named in said user list;
determine if the name of the recipient is named in said user list;
transfer the amount of money of step from the money account of the sender to the money account of the recipient when both the sender and the recipient are named in said user list;
send a virtual certificate to the recipient, allowing the recipient to interact with the processing unit to collect the amount of money of step, when only the sender is named in said user list;
send instruction to the sender, allowing him to interact with the processing unit to credit the amount of money of step to the money account of the recipient, when only the recipient is named in said user list;
